(19) United States
(12) Patent Application Publication
(10) Pub. No.: US 2026/0286160 A1
(43) Pub. Date: Sep. 24, 2026

(54) ALKYLPHENOL ETHOXYLATE FREE COLOR COMPOSITIONS

(71) Applicant: Dow Global Technologies LLC, Midland, MI (US)

(72) Inventors: Jing Ji, Shanghai (CN); Cheng Shen, Shanghai (CN); Bing Liang, Shanghai (CN); Yanguang Zhao, Shanghai (CN)

(21) Appl. No.: 19/477,535

(22) PCT Filed: May 10, 2023
(86) PCT No.: PCT/CN2023/093131

§ 371 Date: Oct. 22, 2025

(51) Int. Cl. C09D 17/00; C08K 5/06; C09D 7/45; C09D 7/63; C09D 7/65

(52) U.S. Cl. CPC C09D 17/001; C09D 7/45; C09D 7/63; C09D 7/65; C09D 17/003; C09D 17/005; C08K 5/06

(57) ABSTRACT

A color composition includes water, a pigment comprising phenyl moieties and a dispersant having Structure (I), wherein R1 and R2 are each independently selected from the group consisting of H, CH3, and CH₂—CH₃, m is a value between 30 and 100, and n is a value from 20 and 40.

### BACKGROUND

### Field of the Invention

The present disclosure generally relates to alkylphenol ethoxylate free compositions, and more specifically to alkylphenol ethoxylate free color compositions.

### INTRODUCTION

Waterborne color compositions typically include a pigment dispersed in water. The color compositions are used in a variety of applications such as coatings, printing ink, textile dying and other applications. For many color compositions, the pigment used typically comprises a plurality of polycyclic aromatic rings (e.g., phenyl moieties) with one or more polar groups positioned on the exterior surface. Examples of such pigments include carbon black and isoindolinone yellow. The molecular structure of the pigments tends to make them highly hydrophobic increasing the difficulty associated with creating waterborne compositions with such pigments. Additionally, the pigments are prone to agglomeration and settling during storage which is not ideal.

When judging the efficacy of a color composition, several properties are key. The first property of interest for the color composition is the viscosity stability over time. Ideally, the viscosity of the color composition should increase by less than 20% when kept at 54° C. for 336 hours (“Viscosity Aging”). An increase in the viscosity of 20% or greater indicates poor dispersion of the pigment particles and settling which would have a negative impact on the application of the pigment. Another key property in evaluating the color composition is the color difference of color coatings produced using the color composition as explained in greater detail below. Ideally, color coatings produced from a color composition should exhibit an initial color difference of less than 0.5 in a non-heat aged state and a color difference of less than 0.5 after heat ageing at 54° C. for 336 hours (“Color Difference Testing”).

Alkylphenol ethoxylates (“APE”) are used as dispersants in color compositions. The alkylphenol moiety of the APE is believed to bond with the aromatic ring moieties of carbon black and other pigments to increase the dispersion of the pigments. The increased dispersion of the pigments minimizes the viscosity increase as well as the color difference exhibited by the color compositions. Recently, APEs have been facing increasing regulatory pressures due to the alkylphenol moiety and may be banned from use in color compositions. Such a ban would have negative impacts on the viscosity increase and the color difference of color compositions moving forward.

In view of the foregoing, it would be surprising and advantageous to discover a dispersant for use in color compositions that is free of alkylphenol moieties, but also allows the color composition to exhibit a viscosity increase of less than 20% after Viscosity Aging and create color coatings that exhibit a color difference of 0.5 or less after Color Difference Testing.

### SUMMARY OF THE DISCLOSURE

The inventors of the present application have surprisingly discovered a dispersant for use in color compositions that is free of alkylphenol moieties, but also allows the color composition to exhibit a viscosity increase of less than 20% after Viscosity Aging and create color coatings that exhibit a color difference of 0.5 or less after Color Difference Testing.

The present disclosure is the result of discovering that dispersants corresponding to Structure (I) provided below are able to achieve the above-noted properties with color compositions. Without being bound by theory, it is believed that the dispersant of Structure (I) is able to achieve the desired properties, despite being absent of alkylphenol moieties, because the amine moieties of the dispersant are able to bond with the polar groups on the exterior of the pigment. Additionally, the alkoxylated moieties of the dispersant increase the dispersion of the pigment by creating steric hinderance between the pigment particles.

According to a first feature of the present disclosure, a color composition comprises, water, a pigment comprising phenyl moieties, and a dispersant having Structure (I) wherein R₁ and R₂ are each independently selected from the group consisting of H, CH₃, and CH₂—CH₃, m is a value between 30 and 100, and n is a value from 20 and 40.

According to a second feature of the present disclosure, the weight average molecular weight of Structure (I) is from 2000 g/mol to 10000 g/mol as measured according to Hydroxyl Value Measurement.

According to a third feature of the present disclosure, the weight average molecular weight of Structure (I) is from 3000 g/mol to 7000 g/mol as measured according to Hydroxyl Value Measurement.

According to a fourth feature of the present disclosure, for Structure (I) of the dispersant, R₁ is H, R₂ is CH₃, m is a value of 95 and n is a value of 26.

According to a fifth feature of the present disclosure, for Structure (I) of the dispersant, R₁ is H, R₂ is CH₃, m is a value of 33 and n is a value of 33.

According to a sixth feature of the present disclosure, the color composition comprises 20 wt % to 50 wt % of the pigment based on the total weight of pigment in the color composition and 20 wt % to 40 wt % of the dispersant based on the total weight of pigment in the color composition.

According to a seventh feature of the present disclosure, the color composition comprises 25 wt % to 30 wt % of the dispersant based on the total weight of pigment in the color composition.

According to an eighth feature of the present disclosure, the color composition further comprises 0.1 wt % to 3.0 wt % of a stabilizer based on the total weight of the color composition, wherein the stabilizer has Structure (II), wherein R is a linear or branched, primary or secondary C₆-C₁₈ alkyl group, each R′ is independently selected from the group consisting of H, CH₃, CH₂—CH₃, and X has an average value from 20 to 60 as measured according to ¹³C Nuclear Magnetic Resonance.

According to a ninth feature of the present disclosure, R of Structure (II) is a branched C₈-C₁₆ alkyl group.

According to a tenth feature of the present disclosure, wherein X of Structure (II) has an average value from 30 to 40 as measured according to ¹³C Nuclear Magnetic Resonance.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, the term weight percent (“wt %”) designates the percentage by weight a component is of a total weight of an indicated composition.

As used herein, a “CAS number” is the chemical services registry number assigned by the Chemical Abstracts Service.

### Color Composition

The present disclosure is directed to a color composition. The color composition comprises water, a pigment, and a dispersant. The color composition comprises 1 wt % or greater of the water based on the total weight of the color composition. For example, the color composition may comprise 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater, or 95 wt % or greater, while at the same time, 99 wt % or less, or 95 wt % or less, or 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less, or 15 wt % or less, or 10 wt % or less of the water based on the total weight of the color composition.

### Pigment

The color composition comprises the pigment. The pigment may comprise one or more phenyl moieties. Examples of pigments useful in the color composition include carbon black, isoindolinone yellow, phthalocyanine blue, phthalocyanine purple, lawsone, anthraquinone, naphthoquinone, beta-carotene, indigo, tyrian purple, alizarin, azobenzene, allura red, chrysoine resorcinol, janus green, azo violet, aniline yellow and/or combinations thereof.

The color composition may comprise from 20 wt % to 50 wt % of the pigment based on the total weight of the color composition. For example, the color composition may comprise 20 wt % or greater, or 22 wt % or greater, or 24 wt % or greater, or 26 wt % or greater, or 28 wt % or greater, or 30 wt % or greater, or 32 wt % or greater, or 34 wt % or greater, or 36 wt % or greater, or 38 wt % or greater, or 40 wt % or greater, or 42 wt % or greater, or 44 wt % or greater, or 46 wt % or greater, or 48 wt % or greater, while at the same time, 50 wt % or less, or 48 wt % or less, or 46 wt % or less, or 44 wt % or less, or 42 wt % or less, or 40 wt % or less, or 38 wt % or less, or 36 wt % or less, or 34 wt % or less, or 32 wt % or less, or 30 wt % or less, or 30 wt % or less, or 28 wt % or less, or 26 wt % or less, or 24 wt % or less, or 22 wt % or less of the pigment based on the total weight of the color composition.

### Dispersant

The color composition comprises the dispersant having Structure (I)

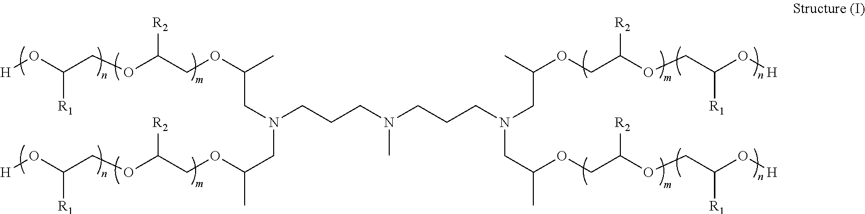

wherein R₁ and R₂ are each independently selected from the group consisting of H, CH₃, and CH₂—CH₃, m is an average value between 30 and 100, and n is an average value from 20 and 40. R₁ and R₂ may be the same or may be different. The m and n values of Structure (I) are measured according to ¹³C Nuclear Magnetic Resonance. It will be understood that each of the m and n values may be independently selected and thus differ from one another. In a specific example of Structure (I), R₁ is H, R₂ is CH₃, m is a value of 95 and n is a value of 26. In another specific example of Structure (I), R₁ is H, R₂ is CH₃, m is a value of 33 and n is a value of 33.

The color composition may comprise 10 wt % to 50 wt % of the dispersant based on the total weight of pigment in the color composition. For example, the color composition may comprise 10 wt % or greater, or 15 wt % or greater, or 20 wt % or greater, or 25 wt % or greater, or 30 wt % or greater, or 35 wt % or greater, or 40 wt % or greater, or 45 wt % or greater, while at the same time, 50 wt % or less, or 45 wt % or less, or 40 wt % or less, or 35 wt % or less, or 30 wt % or less, or 25 wt % or less, or 20 wt % or less, or 15 wt % or less of the dispersant based on the total weight of pigment in the color composition.

The dispersant may have a weight average molecular weight of 2000 g/mol to 10000 g/mol as measured according to Hydroxyl Value Measurement. For example, Structure (I) may have a weight average molecular weight of 2000 g/mol or more, or 3000 g/mol, or 4000 g/mol, or 5000 g/mol, or 6000 g/mol, or 7000 g/mol, or 8000 g/mol, or 9000 g/mol, while at the same time, 10000 g/mol or less, or 9000 g/mol or less, or 8000 g/mol or less, or 7000 g/mol or less, or 6000 g/mol or less, or 5000 g/mol or less, or 4000 g/mol or less, or 3000 g/mol or less as measured according to Hydroxyl Value Measurement.

The dispersant may exhibit a cloud point of greater than 10° C. as measured according to ASTM D2024-09. For example, the cloud point of the stabilizer may be 11° C. or greater, or 15° C. or greater, or 20° C. or greater, or 25° C. or greater, or 30° C. or greater, or 35° C. or greater, or 40° C. or greater, or 45° C. or greater, or 50° C. or greater, or 55° C. or greater, or 60° C. or greater, or 65° C. or greater, or 70° C. or greater, or 75° C. or greater, or 80° C. or greater, or 85° C. or greater, or 90° C. or greater, or 95° C. or greater, while at the same time, 100° C. or less, or 95° C. or less, or 90° C. or less, or 85° C. or less, or 80° C. or less, or 75° C. or less, or 70° C. or less, or 65° C. or less, or 60° C. or less, or 55° C. or less, or 50° C. or less, or 45° C. or less, or 40° C. or less, or 35° C. or less, or 30° C. or less, or 25° C. or less, or 20° C. or less as measured according to ASTM D2024-09.

### Stabilizer

The color composition may comprise a stabilizer. The stabilizer has Structure (II)

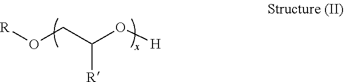

wherein R is a linear or branched, primary or secondary C₆-C₁₈ alkyl group, each R′ is independently selected from the group consisting of H, CH₃, CH₂—CH₃, and X has an average value from 20 to 60 as measured according to ¹³C Nuclear Magnetic Resonance. In a specific example, R of Structure (II) is a branched C₈-C₁₆ alkyl group. The X of Structure (II) may have an average value from 30 to 40 as measured according to ¹³C Nuclear Magnetic Resonance.

The color composition may comprise from 0 wt % to 3.0 wt % of the stabilizer based on the total weight of the color composition. For example, the color composition may comprise 0 wt % or greater, or 0.1 wt % or greater, or 0.2 wt % or greater, or 0.4 wt % or greater, or 0.6 wt % or greater, or 0.8 wt % or greater, or 1.0 wt % or greater, or 1.2 wt % or greater, or 1.4 wt % or greater, or 1.6 wt % or greater, or 1.8 wt % or greater, or 2.0 wt % or greater, or 2.2 wt % or greater, or 2.4 wt % or greater, or 2.6 wt % or greater, or 2.8 wt % or greater, while at the same time, 3.0 wt % or less, or 2.8 wt % or less, or 2.6 wt % or less, or 2.4 wt % or less, or 2.2 wt % or less, or 2.0 wt % or less, or 1.8 wt % or less, or 1.6 wt % or less, or 1.4 wt % or less, or 1.2 wt % or less, or 1.0 wt % or less, or 0.8 wt % or less, or 0.6 wt % or less, or 0.4 wt % or less, or 0.2 wt % or less of the stabilizer based on the total weight of the color composition.

The stabilizer may exhibit a cloud point of greater than 80° C. as measured according to ASTM D2024-09. For example, the cloud point of the stabilizer may be 81° C. or greater, or 85° C. or greater, or 90° C. or greater, or 95° C. or greater, while at the same time, 100° C. or less, or 90° C. or less as measured according to ASTM D2024-09.

### EXAMPLES

### Materials

The following materials were used in the formation of the comparative examples (“CE”) and the inventive examples (“IE”).

CB is carbon black pigment commercially available as Pigment Black A from Shanghai Hanying, Shanghai, China.

STAB1 is an alcohol ethoxylate co-dispersant agent available as EMULSOGEN™ LCN 407 that is 70 wt % actives from Clariant AG Muttenz, Switzerland.

DISP1 is an alkoxylated Novolac dispersant available as DISPERSOGEN™ 2774 from Clariant AG Muttenz, Switzerland.

STAB2 is a secondary alcohol ethoxylate (branched C₁₂~C₁₄ with 40EO) having a cloud point of a 1 wt. % aqueous solution is >100° C. and is available from The Dow Chemical Company, Midland, Michigan, USA.

DISP2 is Structure (I) where R₁ is H, R₂ is CH₃, m is a value of 95 and n is a value of 26, Mw is about 6800 as measured according to Hydroxyl Value Measurement, cloud point of 1 wt. % aqueous solution is 22° C. and is commercially available from The Dow Chemical Company, Midland, Michigan, USA.

STAB3 is an alkoxylated primary alcohol having a branched C₈ alkyl with 5 moles of propylene oxide and 40 moles of ethylene oxide, a cloud point of >100° C. in a 1 wt. % aqueous solution and is available from The Dow Chemical Company, Midland, Michigan, USA.

DISP3 is Structure (I) where R₁ is H, R₂ is CH₃, m is a value of 33 and n is a value of 33, Mw is about 3500 as measured according to Hydroxyl Value Measurement, cloud point of 1 wt. % aqueous solution is 63° C. and is available from The Dow Chemical Company, Midland, Michigan, USA.

AF is an antifoaming agent commercially available as NOPCO™ NXZ from Sanyo Chemical Industries, LTD, Kyoto Japan.

AFREZ is propylene glycol from Sinopharm Chemical Reagent Company, Shanghai, China.

PH is a pH neutralizer commercially available as AMP-95™ from Angus Chemical Company, Buffalo Grove, Illinois, USA.

PY110 is isoindolinone yellow and may be commercially obtained from Kremer Pigments Inc., New York, New York.

### Test Methods

Krebs unit (“KU”) viscosity was measured in accordance with ASTM D562, using a Brookfield Viscometer (KU-2 Digital Stormer-type viscometer) at 25° C.±0.2° C.

Viscosity Ageing: Samples were stored in a sealed plastic bottle and then put into a UF 110 oven from MEMMERT at 54° C. for 336 hours (i.e., two weeks) to produce aged samples.

Color difference testing was performed by the rub up test method. First the color composition was added into a coating (pure acrylic coating for interior wall, 51% pigment volume concentration, 15% TiO2 with the balance being binder, water, surfactant, dispersant, filler, and thickener) at 1 wt % based on the total weight of the combined coating and color composition and shaken by an HT-30 automatic rotary mixer from Shanghai Modern Environment for 6 minutes to obtain a colored coating. Once the colored coating was formed, a coating layer with thickness of approximately 150 um was prepared on a paper plate using a special applicator with a 150 um groove to ensure uniform layer thickness. After 1 minute of drying, the coating was partially wiped by circling the right middle finger of a technician gently over the coating. The diameter of the circle was around 3 cm to 4 cm, and a total of 45 circles. Smooth and uniform wiping was needed to prevent from wearing through the coating film. The coating films were kept at 23° C. for 24 hours. Afterwards, the color difference of the wiped and non-wiped area was measured by a Spectro guide sphere gloss-S colorimeter from BYK. Next, the samples were then put into a UF 110 oven from MEMMERT at 54° C. for 336 hours (i.e., two weeks) to produce aged samples. After the allotted time, the coatings were taken out and the color difference of the wiped and non-wiped area was measured by a Spectro guide sphere gloss-S colorimeter from BYK.

Hydroxyl Value Measurement was measured according to ASTM D4274.

Cloud point was measured according to ASTM D2024-09.

### Sample Preparation

The color composition samples were prepared according to the following guidelines. First, the water, stabilizer and dispersant were placed in a 100 milliliter (“mL”) beaker, and then mixed with a RW 20 Digital overhead stirrer from IKA to form a mixture. The mixture was stirred at 500 revolutions per minute (“RPM”) for 15 minutes until the stabilizer and dispersant were completely dissolved in the water. While still stirring, the anti-foaming agent (AF), anti-freezing agent (AFREZ) and pH neutralizer (PH) were added to the mixture and mixed at 500 RPM for 5 minutes. Next, the mixing was stopped, and the indicated pigment was added into the solution. The pigment and mixture were mixed with a stainless-steel rod for 5 minutes to form a uniform color composition. The color composition was poured into the stainless-steel jar of 200 mL sand miller from Shenyan Ge Rui Si together with the grinding beads. The weight of the beads was 1.5 times of the weight of color composition. Next, the color composition was ground at 4000 RPM for 1 hour. After grinding, the color composition was filtered with 100 mesh sieves to remove the beads and obtain the finished color composition.

### Results

Table 1 provides the composition of CE1, CE2 and IE1-IE5.

TABLE 1

| Material (g) | CE1 | CE2 | IE1 | IE2 | IE3 | CE3 | IE4 | IE5 |
|---|---|---|---|---|---|---|---|---|
| CB | 36 | 36 | 36 | 36 | 36 | | | |
| PY110 | | | | | | 36 | 36 | 36 |
| STAB1 | 2.9 | | | | | 2.9 | | |
| DISP1 | 10 | | | | | 10 | | |
| STAB2 | | 2.9 | | | | | | |
| DISP2 | | 6 | | | | | | |
| STAB2 | | | 2.9 | | | | 2.9 | |
| DISP2 | | | 10 | | | | 10 | |
| STAB3 | | | | 2.7 | | | | 2.7 |
| DISP3 | | | | 10 | | | | 10 |
| DISP2 | | | | | 10 | | | |
| AF | 0.2 | 0.2 | 0.2 | 0.2 | 0.2 | 0.2 | 0.2 | 0.2 |
| AFREZ | 5 | 5 | 5 | 5 | 5 | 5 | 5 | 5 |
| PPH | 0.2 | 0.2 | 0.2 | 0.2 | 0.2 | 0.2 | 0.2 | 0.2 |
| Water | 45.7 | 45.7 | 45.7 | 45.9 | 48.6 | 45.7 | 45.7 | 45.9 |
| Total | 100 | 100 | 100 | 100 | 100 | 100 | 100 | 100 |

Table 2 provides the results of the IE and CE color composition's viscosity testing data.

TABLE 2

| Tested | | | | | | | | | |
|---|---|---|---|---|---|---|---|---|---|
| Property | Unit | CE1 | CE2 | IE1 | IE2 | IE3 | CE3 | IE4 | IE5 |
| Viscosity | KU | 84 | 66.8 | 65.8 | 56.5 | 70.3 | 54.7 | 56.3 | 50.7 |
| (initial) | | | | | | | | | |
| Viscosity | KU | 101.1 | 78.2 | 77.4 | 63.1 | 83.1 | 61.3 | 62.8 | 56.8 |
| (aged) | | | | | | | | | |
| Viscosity | % | 20.4% | 17.1% | 17.6% | 11.7% | 18.2% | 12.1% | 11.5% | 12.0% |
| Increase | | | | | | | | | |

As can be seen in Table 2, the increase in viscosity of IE1-IE5 is the same, or less than, the increase in viscosity accomplished by CE1-CE3. Specifically, the initial viscosity of the color composition with IE1, IE2 and IE3 was lower than the initial viscosity obtained with CE1. Such a result indicates that the dispersing efficiency of the IEs was higher than CE1. Further, the data from the heat aged samples indicates that the IEs exhibit the same or better heat stability than the CEs.

Table 3 provides the results of the IE and CE color composition's color difference testing data.

TABLE 3

| Tested Property | CE1 | CE2 | IE1 | IE2 | IE3 | CE3 | IE4 | IE5 |
|---|---|---|---|---|---|---|---|---|
| Color difference | 0.12 | 1.61 | 0.11 | 0.30 | 0.22 | 0.21 | 0.07 | 0.12 |
| (initial) | | | | | | | | |
| Color difference | 0.04 | N/A | 0.09 | 0.12 | 0.19 | 0.27 | 0.19 | 0.26 |
| (aged) | | | | | | | | |

Referring now to Table 3, provided is the color difference data for the color compositions. As can be seen, the color difference of the coatings for IEs was comparable with the color development of the coating with CE1 and CE3. For CE2, the initial color difference was too high and thus a heat aged sample was not produced. IE1-IE5 demonstrate a color difference value well below the targeted 0.5 value and as such are successful.

As shown by the data of Tables 2 and 3, color compositions comprising water, a pigment and a dispersant having Structure (I) are able to achieve the targeted viscosity stability as well as the target color difference despite being free of alkylphenol ethoxylates.

What is claimed is:

1. A color composition, comprising:
water;
a pigment comprising phenyl moieties; and
a dispersant having Structure (I) 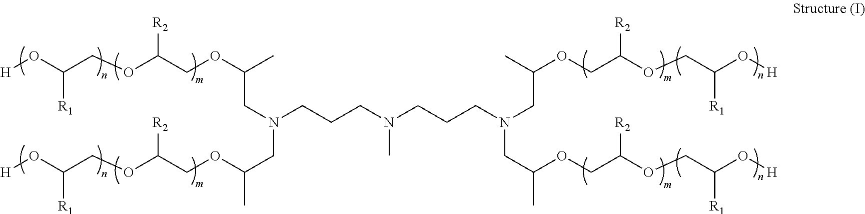
wherein R₁ and R₂ are each independently selected from the group consisting of H, CH₃, and CH₂—CH₃, m is a value between 30 and 100, and n is a value from 20 and 40.

2. The color composition of claim 1, wherein the weight average molecular weight of Structure (I) is from 2000 g/mol to 10000 g/mol as measured according to Hydroxyl Value Measurement.

3. The color composition of claim 2, wherein the weight average molecular weight of Structure (I) is from 3000 g/mol to 7000 g/mol as measured according to Hydroxyl Value Measurement.

4. The color composition of claim 1, wherein for Structure (I) of the dispersant, R₁ is H, R₂ is CH₃, m is a value of 95 and n is a value of 26.

5. The color composition of claim 1, wherein for Structure (I) of the dispersant, R₁ is H, R₂ is CH₃, m is a value of 33 and n is a value of 33.

6. The color composition of claim 1, wherein the color composition comprises:
20 wt % to 50 wt % of the pigment based on the total weight of the color composition; and
20 wt % to 40 wt % of the dispersant based on the total weight of pigment in the color composition.

7. The color composition of claim 6, wherein the color composition comprises 25 wt % to 30 wt % of the dispersant based on the total weight of pigment in the color composition.

8. The color composition of claim 1, wherein the color composition further comprises:
0.1 wt % to 3.0 wt % of a stabilizer based on the total weight of the color composition, wherein the stabilizer has Structure (II) 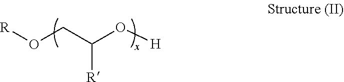
wherein R is a linear or branched, primary or secondary C₆-C₁₈ alkyl group, each R′ is independently selected from the group consisting of H, CH₃, CH₂—CH₃, and X has an average value from 20 to 60 as measured according to ¹³C Nuclear Magnetic Resonance.

9. The color composition of claim 8, wherein R of Structure (II) is a branched C₈-C₁₆ alkyl group.

10. The color composition of claim 8, wherein X of Structure (II) has an average value from 30 to 40 as measured according to ¹³C Nuclear Magnetic Resonance.
